(19) United States
(12) Patent Application Publication
(10) Pub. No.: US 2006/0035666 A1
(43) Pub. Date: Feb. 16, 2006

(54) Method for transmitting data signals via wireless communication device during conversation

(75) Inventors: Cheng-Shing Lai, Taipei (TW); Xiao-Long Fan, Nanking (CN); Tao Long, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/135,361

(22) Filed: May 24, 2005

(30) Foreign Application Priority Data
Aug. 11, 2004 (TW) 093124015

(51) Int. Cl. H04M 1/00

(52) U.S. Cl. 455/552.1; 455/553.1

(57) ABSTRACT

The prevent invention is to provide a method for transmitting data signals via a wireless communication device during conversation, wherein the wireless communication device, with at least two telephone system interfaces, can employ one of the system interfaces to conduct conversation and use the other telephone system interface to transmit or receive data signals of picture or text. Thus, a user at the remote end can easily understand the verbal language with the aid of the picture or text being transmitted.

### FIELD OF THE INVENTION

The present invention relates generally to a wireless communication device, more particularly to a method for transmitting data signals via the wireless communication device during conversation.

### BACKGROUND OF THE INVENTION

In this fast-paced and rapid-changing metropolitan living environment, wireless communication devices not only became one of the most convenient communication tools, but also included a variety of functions, such as game software, phone book service, voice mail system, calculator, alarm, wireless application protocol (WAP), text messaging, electronic mail, etc., to provide users with additional services. Following this trend, a multi-function wireless communication device is developed to satisfy the users' need.

However, conventional wireless communication devices can not transmit data signals (such as sending and receiving text message, electronic mail, etc.) during conversation. Or, on the other hand, no conversation can be conducted during data transmission. This is rather inconvenient especially when ideas are not clearly conveyed by verbal language without the aid of pictures (or text).

### SUMMARY OF THE INVENTION

In light of the description set forth above, the conventional wireless communication device is disadvantageous in that no data signal can be transmitted during conversation and that no conversation can be conducted during data transmission. For this reason, the inventors of the present invention carefully studied and experimented all possible solutions to the conventional drawbacks based on their background experiences in the industry of communication products. Finally, a method for transmitting data signals via a wireless communication device during conversation has been developed. The drawbacks of the conventional wireless communication device are thus eliminated.

It is an object of the present invention to provide a method for transmitting data signals via a wireless communication device during conversation.

In order to achieve the above and other objects, the wireless communication device comprises at least two telephone system interfaces. The wireless communication device can employ one of the telephone system interfaces to conduct conversation, and use the other telephone system interface to receive commands of data signal transmission. The conversation conducted via one of the telephone system interfaces will be maintained, when data signals (e.g. text messages, and electronic mails) are being transmitted via the other telephone system interface. Therefore, when the use of verbal language is insufficient to clearly convey the ideas, one can transmit either a picture or a text to aid the conversation without terminating the phone call. The user at the remote end can thus easily understand the verbal language with the aid of the transmitted picture or text.

It is another object of the present invention to provide a method for transmitting data signals via a wireless communication device during conversation, wherein the wireless communication device comprises two telephone system interfaces. One of the telephone system interface is the Personal Handyphone System (PHS), while the other is the Global System for Mobile Communications (GSM). The wireless communication device can use the PHS to conduct conversation, and use the GSM to transmit data signals. Similarly, the wireless communication device can use the PHS to transmit data signals, and use the GSM to conduct conversation.

The above and other objects, features and advantages of the present invention will become apparent from the following detailed description taken with the accompanying drawings.

### BRIEF DESCRIPTION OF THE DRAWINGS

FIG. 1 is a flow diagram of the present invention.

### DETAILED DESCRIPTION OF THE PREFERRED EMBODIMENTS

The present invention provides a method for transmitting data signals via a wireless communication device during conversation. The wireless communication device comprises at least two telephone system interface, so as to conduct conversation (or transmit data signals, such as sending and receiving text messages, electronic mails, wireless application protocol (WAP), and browsing web pages, etc.) using at least one of the telephone system interface. In this manner, the wireless communication device can conduct conversation by using one of the telephone system interfaces, and receive data signals by using another telephone system interface. Consequently, the data signals (such as text messages, or electronic mails) to be displayed at the remote end can be transmitted via another telephone system interface without terminating the current conversation. The user at the remote end can thus better understand the content of conversation.

In one embodiment of the present invention, the wireless communication device comprises two telephone system interfaces. One of the telephone system interfaces is the Personal Handyphone System (PHS), while the other is the Global System for Mobile Communications (GSM). The wireless communication device can also use the PHS to conduct conversation, and use the GSM to transmit data signals. Similarly, the wireless communication device can use the PHS to transmit data signals, and use the GSM to conduct conversation. Hence, the user can connect to the Internet and browse web pages during conversation. Furthermore, the user can also send text messages (or electronic mails) to the remote end, so as to enable the user at the remote end to better understand the ideas to be conveyed.

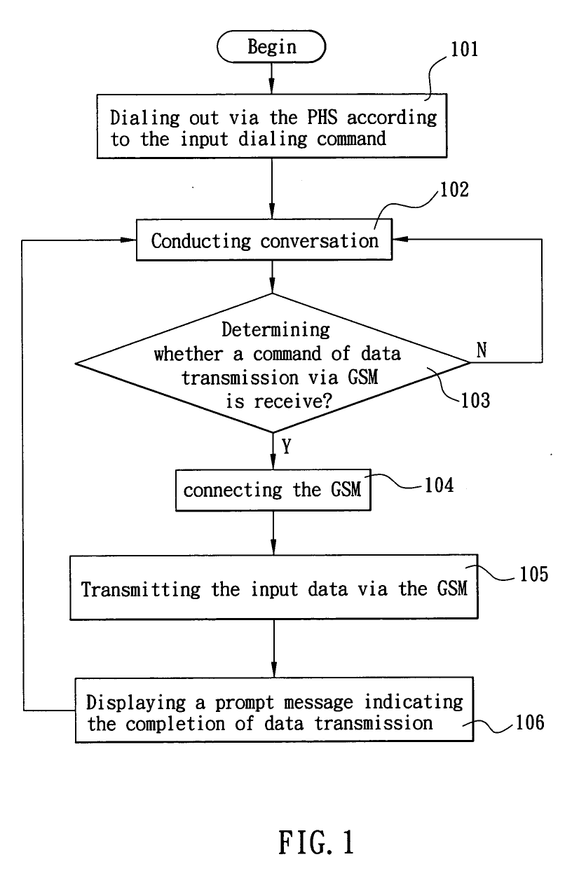

Referring to FIG. 1, in accordance with the particular embodiment described above, the wireless communication device performs the following steps:

First, in step 101, the wireless communication device dials out via the PHS according to the input dialing command;

In step 102, conversion is conducted;

In step 103, the wireless communication device determines whether a command of data transmission via the GSM is received or not, If yes, the process skips to step 104. Otherwise, the process loops back to step 102;

In step 104, the wireless communication device connects to the GSM;

In step 105, the wireless communication device transmits the entered data (e.g. picture data) via the GSM.

In step 106, after completing the transmission process, a prompt message is shown on the display of the wireless communication device indicating that the transmission process is completed, and then returning to step 102.

Accordingly, the method of the present invention allows the wireless communication device to transmit data signals during conversation. When the use of verbal language is insufficient to clearly convey the ideas, one can transmit either a picture or a text to aid the conversation without terminating the phone call. Therefore, the user at the remote end can easily understand the verbal language with the aid of the transmitted picture or text.

While the invention has been described by means of specific embodiments, numerous modifications and variations could be made thereto by those skilled in the art without departing from the scope and spirit of the invention set forth in the claims.

What is claimed is:

1. A method for transmitting data signals via a wireless communication device during conversation, the wireless communication device comprising at least two telephone system interface, wherein any one of the telephone system interfaces being used to conduct a conversation, or transmit or receive data signals, enabling the wireless communication device to continue the conversation conducted via one of the telephone system interface, while the data signals being transmitted or received via the other telephone system interface.

2. The method of claim 1, wherein one of the telephone system interface is a personal handyphone system (PHS), and the other telephone system interface is a global system for mobile communications (GSM).
